(19) United States
(12) Patent Application Publication
(10) Pub. No.: US 2024/0221512 A1
(43) Pub. Date: Jul. 4, 2024

(54) METHOD AND SYSTEM FOR MANAGING AN AIR COMBAT MISSION ON A BATTLESPACE

(71) Applicant: The Boeing Company, Chicago, IL (US)

(72) Inventors: Jessica Arbona, Berkeley, MO (US); John Russell Girotto, Saint Louis, MO (US); Jon Peter Silverberg, St Charles, MO (US)

(21) Appl. No.: 18/150,024

(22) Filed: Jan. 4, 2023

(51) Int. Cl. G08G 5/00; F41G 9/00

(52) U.S. Cl. CPC G08G 5/0039; F41G 9/002; G08G 5/0034

(57) ABSTRACT

The subject matter described herein includes a system and method for managing an air combat mission on a battlespace for one or more aircraft. The one or more aircraft receive a battle plan for the combat mission. The battle plan is then broken down into different mission plans for each aircraft. The mission plan includes tasks to be completed by each aircraft and a route for each aircraft to take during the mission. If the battlespace changes during the mission, the system is configured to update the mission plans for appropriate ones of the aircraft to address the change to the battlespace so that the mission continues towards completion. The system further includes the ability to create and evaluate alternative courses of action prior to selection as the primary or currently executing plan.

### BACKGROUND

### Field of the Disclosure

The present disclosure is generally related to aircraft combat missions. More particularly, the present disclosure is related to managing aircraft combat missions on a battlespace.

### Description of Related Art

Modern warfare requires precise communication between aircraft to accomplish a shared objective. The increasingly complex and dense nature of the modern battlespace has led to an increasing need for in-aircraft analytical tools which evaluate the environment of the battlespace and manage platform response, including coordination between aircraft. When those tools run independently in parallel, an increasing number of concurrent tools often decreases the comprehensibility, mission relevance, and coherence of their collective output. Available solutions lack an architecture to apply a diverse automated tool set within the guiding construct of established tactics and procedures to facilitate cohesion and operator insight into applied automation. Current analytical tools and algorithms focus on analyzing a particular facet of the battlespace in relative isolation and an increasing number of tools and algorithms are applied concurrently without unifying guidance.

It would therefore be desirable to have a system and method that takes into account at least some of the issues discussed above, as well as other possible issues. Further, it would be desirable to have system and method which coordinates an extensible suite of tools in the full context of the battlespace.

### SUMMARY

Example implementations of the present disclosure are directed to a method and system for managing an air combat mission on a battlespace for one or more aircraft. The features described herein allow for managing and reconciling the output of disparate analytical tool sets in aircraft. More particularly, features described herein detail the coordination of platform automation services through the application of pre-generated profiles, which guide platform autonomy to behave according to the relevant established strategy, tactic, doctrine, and procedure that better produces unified results which align to operational context.

The method and system described herein include one or more aircraft receiving a battle plan for the combat mission. The battle plan is then broken down into different mission plans for each aircraft. The mission plan includes tasks to be completed by each aircraft and a route for each aircraft to take during the mission. If the battlespace changes during the mission, the system is configured to update the mission plans for appropriate ones of the aircraft to address the change to the battlespace so that the mission continues towards completion. The system further includes the ability to create and evaluate alternative courses of action prior to selection as the primary or currently executing plan.

The present disclosure thus includes, without limitation, the following example implementations.

Some example implementations provide a method for managing an air combat mission on a battlespace for one or more aircraft, the method comprising: receiving a battle plan by each of the one or more aircraft, the battle plan comprising one or more mission objectives, each mission objective containing desired battle space effects, guidance, and aircraft constraints for implementation by one or more of the aircraft as part of the battle plan; generating, from the battle plan, a separate mission plan for each of the one or more aircraft, each mission plan including task sets for completion by a corresponding aircraft and a route to be traversed by the corresponding aircraft, each task set including tasks, which when completed, are designed to achieve one of the one or more mission objectives including achieving the desired battle space effects, guidance, and aircraft constraints of the mission objective; executing each mission plan, including each aircraft traversing the route and completing the tasks from the task sets of a corresponding mission plan; generating a revised mission plan for at least one selected aircraft based on observed real-time battlespace conditions, the revised mission plan including one or more adjustments to the route or task sets of the corresponding mission plan; executing the revised mission plan, including the selected aircraft traversing the adjusted route or completing the adjusted task set; and transmitting the revised mission plan to each aircraft, other than the at least one selected aircraft, for revising their corresponding mission plans.

In some example implementations of the method of any preceding example implementation, or any combination thereof, generating the mission plans from the battle plans comprises: determining mission requirements for subsystems of each aircraft based on the received mission objective to be completed during execution of the mission plan, and based on expected battlespace conditions; and generating the task sets and the route based on the determined mission requirements.

In some example implementations of the method of any preceding example implementation, or any combination thereof, generating the revised mission plan comprises: determining revised mission requirements for subsystems of each aircraft based on the received mission objective to be completed during execution of the mission plan, and based on the observed real-time battlespace conditions; and adjusting the task sets and the route based on the determined revised mission requirements.

In some example implementations of the method of any preceding example implementation, or any combination thereof, further comprising displaying instructions for executing each mission plan or each revised mission plan on an onboard computer display of a corresponding aircraft.

In some example implementations of the method of any preceding example implementation, or any combination thereof, each mission objective further contains one or more pre-loaded template mission plans for execution by an aircraft, and wherein generating the mission plans comprises using the pre-loaded template mission plans to generate the mission plans, the pre-loaded template mission plans comprising pre-made task sets and routes being representative of a pre-determined decision making or task prioritization process.

In some example implementations of the method of any preceding example implementation, or any combination thereof, generating the mission plans further comprises altering the pre-loaded template mission plan based on expected battlespace conditions to generate the mission plans.

In some example implementations of the method of any preceding example implementation, or any combination thereof, altering the pre-loaded template mission plan includes altering the pre-loaded template mission plan based on observed actual battlespace conditions, including environmental conditions, obstacles, or enemy combatant locations or activities.

In some example implementations of the method of any preceding example implementation, or any combination thereof, the method further comprises receiving the observed real-time battlespace conditions from one or more ground-based radar devices, one or more airborne devices, one or more ground-based sensors, or one or more airborne sensors arranged to monitor and track one or more locations on the battlespace, positions of the one or more aircraft, and positions of one or more enemy aircraft on the battlespace.

In some example implementations of the method of any preceding example implementation, or any combination thereof, generating the mission plan for each of the aircraft includes generating a plurality of mission plan options from which a pilot of a corresponding aircraft is able to select to execute.

In some example implementations of the method of any preceding example implementation, or any combination thereof, routes and task sets of the mission plan options are editable by the pilot.

Some other example implementations provide a system for managing an air combat mission on a battlespace for one or more aircraft, the system comprising: one or more processors, each including non-transitory computer readable storage medium having executable instructions stored thereon, each of the one or more aircraft having one of the one or more processors onboard, wherein upon execution of the executable instructions, the one or more processors is configured to: receive a battle plan by each of the one or more aircraft, the battle plan comprising one or more mission objectives, each mission objective containing desired battle space effects, guidance, and aircraft constraints for implementation by one or more of the aircraft as part of the battle plan; generate, from the battle plan, a separate mission plan for each of the one or more aircraft, each mission plan including task sets for completion by a corresponding aircraft and a route to be traversed by the corresponding aircraft, each task set including tasks, which when completed, are designed to achieve one of the one or more mission objectives including achieving the desired battle space effects, guidance, and aircraft constraints of the mission objective; execute each mission plan, including each aircraft being configured to traverse the route and complete the tasks from the task sets of a corresponding mission plan; generate a revised mission plan for at least one selected aircraft based on observed real-time battlespace conditions, the revised mission plan including one or more adjustments to the route or task sets of the corresponding mission plan; execute the revised mission plan, including the selected aircraft being configured to traverse the adjusted route or complete the adjusted task set; and transmit the revised mission plan to each aircraft, other than the at least one selected aircraft, for revising their corresponding mission plans.

In some example implementations of the system of any preceding example implementation, or any combination thereof, the one or more processors is further configured to: determine mission requirements for subsystems of each aircraft based on the received mission objective to be completed during execution of the mission plan, and based on expected battlespace conditions; and generate the task sets and the route based on the determined mission requirements.

In some example implementations of the system of any preceding example implementation, or any combination thereof, the one or more processors is further configured to: determine revised mission requirements for subsystems of each aircraft based on the received mission objective to be completed during execution of the mission plan, and based on the observed real-time battlespace conditions; and adjust the task sets and the route based on the determined revised mission requirements.

In some example implementations of the system of any preceding example implementation, or any combination thereof, the one or more processors is further configured to display instructions for executing each mission plan or each revised mission plan on an onboard computer display of a corresponding aircraft.

In some example implementations of the system of any preceding example implementation, or any combination thereof, each mission objective further contains one or more pre-loaded template mission plans for execution by an aircraft, and wherein the one or more processors is further configured to use the pre-loaded template mission plans to generate the mission plans, the pre-loaded template mission plans comprising pre-made task sets and routes being representative of a pre-determined decision making or task prioritization process.

In some example implementations of the system of any preceding example implementation, or any combination thereof, the one or more processors is further configured to alter the pre-loaded template mission plan based on expected battlespace conditions to generate the mission plans.

In some example implementations of the system of any preceding example implementation, or any combination thereof, the one or more processors is further configured to alter the pre-loaded template mission plan based on observed actual battlespace conditions, including environmental conditions, obstacles, or enemy combatant locations or activities.

In some example implementations of the system of any preceding example implementation, or any combination thereof, the one or more processors is further configured to receive the observed real-time battlespace conditions from one or more ground-based radar devices, one or more airborne devices, one or more ground-based sensors, or one or more airborne sensors arranged to monitor and track one or more locations on the battlespace, positions of the one or more aircraft, and positions of one or more enemy aircraft on the battlespace.

In some example implementations of the system of any preceding example implementation, or any combination thereof, the one or more processors is further configured to generate a plurality of mission plan options from which a pilot of a corresponding aircraft is able to select to execute.

In some example implementations of the system of any preceding example implementation, or any combination thereof, routes and task sets of the mission plan options are editable by the pilot

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates an example battlespace, according to some embodiments of the present disclosure;

FIG. 2 illustrates a system block diagram of an example system for managing a mission, according to some embodiments of the present disclosure;

FIG. 3A illustrates the battlespace with a discrete instance of the system onboard each of the aircraft in the battlespace, according to some embodiments of the present disclosure;

FIG. 3B illustrates a communication environment, according to some embodiments of the present disclosure;

FIG. 4 illustrates a flow chart detailing steps of an example method, according to some embodiments of the present disclosure; and

FIG. 5 illustrates an example apparatus for performing the method and other functions described herein, according to some embodiments of the present disclosure.

### DETAILED DESCRIPTION OF THE DISCLOSURE

Some examples of the present disclosure will now be described more fully hereinafter with reference to the accompanying drawings, in which some, but not all aspects of the disclosure are shown. Indeed, various examples of the disclosure is embodied in many different forms and should not be construed as limited to the examples set forth herein; rather, these examples are provided so that this disclosure will be thorough and complete, and will fully convey the scope of the disclosure to those skilled in the art. For example, unless otherwise indicated, reference to something as being a first, second or the like should not be construed to imply a particular order. Also, something described as being above something else (unless otherwise indicated) is below, and vice versa; and similarly, something described as being to the left of something else is to the right, and vice versa. Like reference numerals refer to like elements throughout.

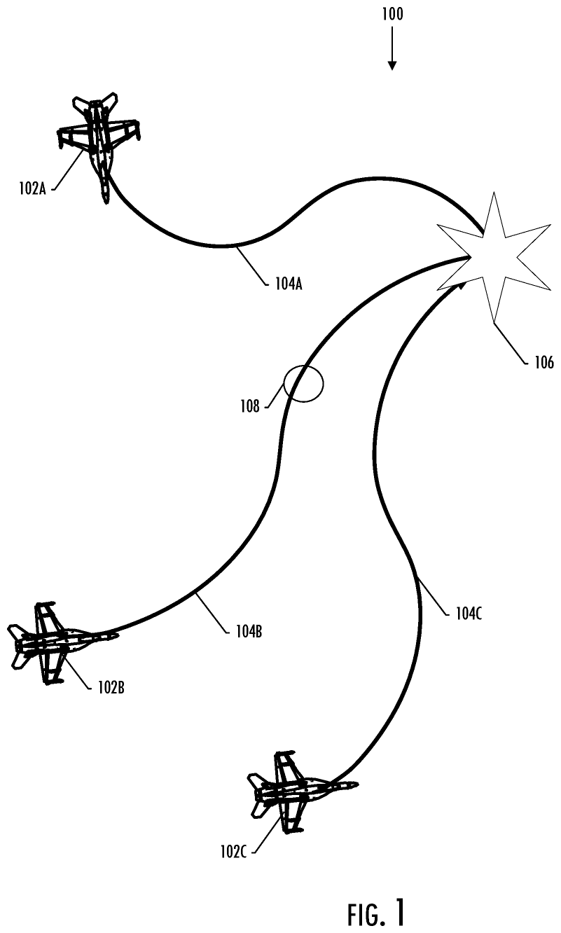

FIG. 1 illustrates an example battlespace 100 according to some implementations of the present disclosure. The battlespace includes one or more aircraft, such as first aircraft 102A, second aircraft 102B, and third aircraft 102C. Each of the one or more aircraft are working cooperatively to accomplish mission objectives of a battle plan. For example, the mission objectives include each aircraft following along respective routes, such as first route 104A for first aircraft, second route 104B for second aircraft, and third route 104C for third aircraft, clearing the battlespace of enemy combatants or delivering one or more pieces of equipment to delivery location 106. The collective goal of the one or more aircraft is to complete a battle plan, and each of the aircraft has their own mission plan where execution of each mission plan completes objectives of the battle plan. Each mission plan of the aircraft might change based on real-time observations on the battlespace. Additionally, each mission plan gives specific guidance to systems and subsystems of the corresponding aircraft which is executing the mission plan.

For example, the mission plan for second aircraft 102B includes eliminating a target 108 along the second route 104B. In order to complete this specific task, the aircraft will include a weapons subsystem (e.g., a missile subsystem) and a task of the mission plan of the second aircraft will include the weapons subsystem delivering a missile to the target. Notably, the aircraft, especially combat aircraft, have many other subsystems of varying levels of complexity. The present disclosure should not be construed so as to limit the method and system 200 described herein to only weapons firing or package delivery. Any number of tasks and missions are accomplished by the aircraft executing the method and system described herein. Additionally, any number of subsystems of the aircraft are engaged according to the mission plan of the corresponding aircraft.

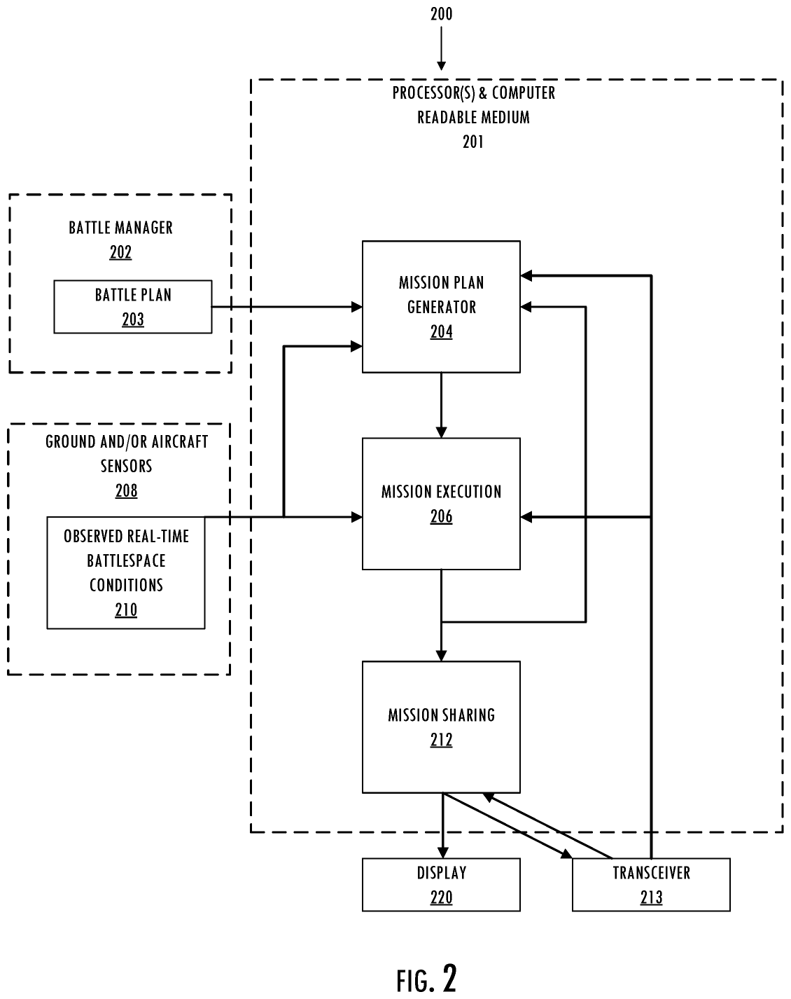

FIG. 2 illustrates an example system 200 for managing an air combat mission on a battlespace 100 for one or more aircraft, according to some implementations of the present disclosure. In some example implementations, when referred to herein, the system refers to one instance of the system illustrated in FIG. 2 or multiple instances. For example, the system 200 refers to the system being located on a first aircraft alone. Alternatively, the system refers to multiple instances of the system from FIG. 2, one instance being located on a first aircraft, a second instance being located on a second aircraft, and a third instance being located on a third aircraft. In some examples, when referring to the system herein, the present disclosure refers to collective action of the different instances of the system or it refers to individual action of an instance of the system, for example, one instance on a single aircraft.

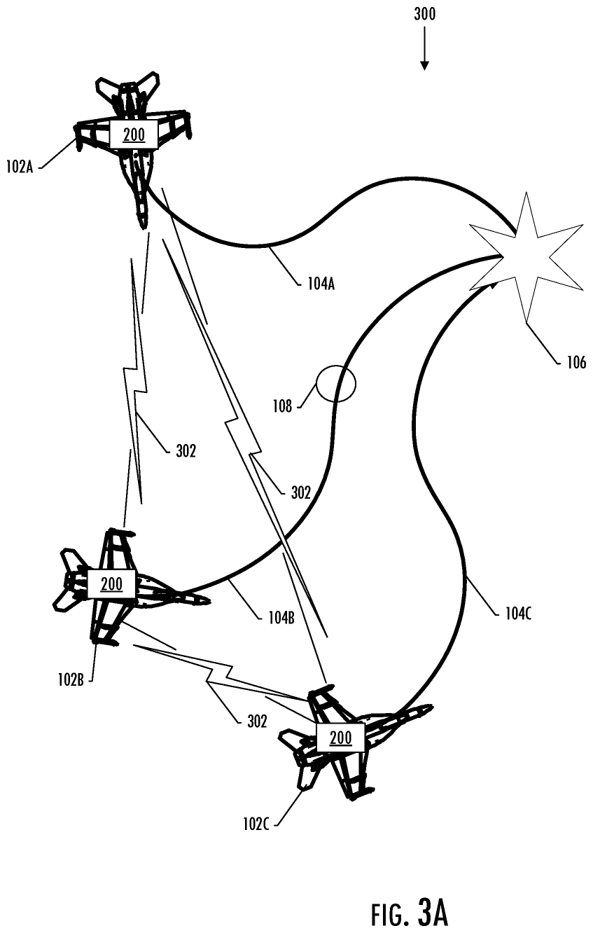

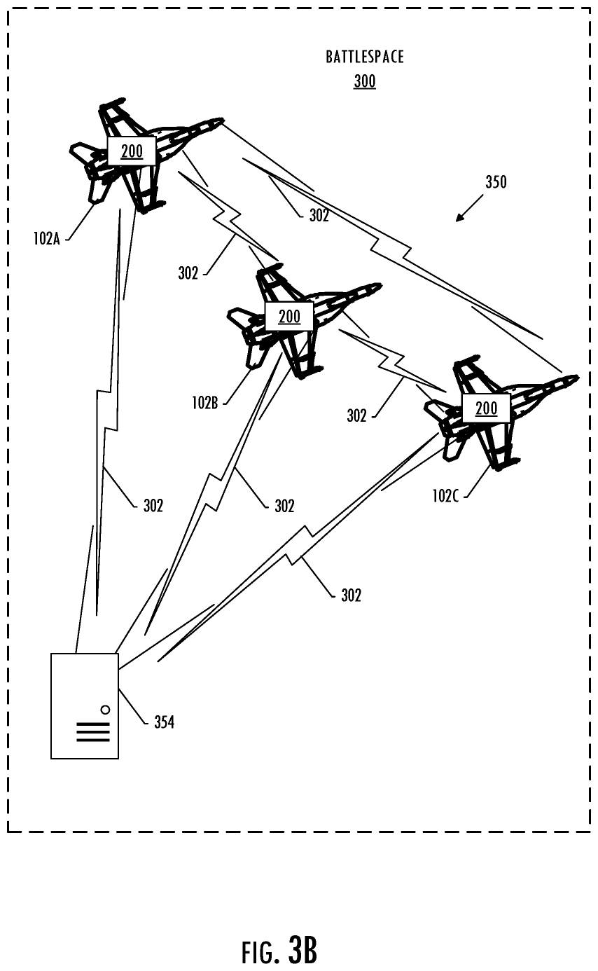

In some implementations, the system 200 comprises one or more processors 201, each including a non-transitory computer readable storage medium having executable instructions stored thereon. As described in further detail below, in some example implementations, each of the one or more aircraft, such as first aircraft 102A, second aircraft 102B, and third aircraft 102C shown in FIG. 3A, comprise one of the one or more processors onboard.

The system 200 includes a mission plan generator 204 operated by the one or more processors 201. The mission plan generator is configured to receive, from a battle manager 202, a battle plan 203. The battle manager manages mission-level timelines and objectives across the one or more aircraft to coordinate, link, and divide tasking, identify various dependencies, and evaluate or adjust to real-time progression of the mission objectives. The battle manager is implemented by a computing system such as ground station 354 illustrated in FIG. 3B. The battle plan comprises one or more mission objectives, each mission objective containing desired battle space effects, guidance, and aircraft constraints for implementation by one or more of the aircraft, such as first aircraft 102A, second aircraft 102B, and third aircraft 102C shown in FIG. 3A, as part of the battle plan. As described herein, each of the aircraft includes an instance of the system and therefore, each of the aircraft includes a mission plan generator configured to receive the battle plan. Alternatively, in some implementations, the battle manager is also onboard the one or more aircraft, and each aircraft has its own battle manager thereon with the functionality described herein synchronized between the instances on each of the aircraft.

The mission plan generator 204 is further configured to generate, from the battle plan 203, a mission plan including task sets for completion by a corresponding aircraft. For example, each instance of the mission plan generator is configured to generate, from the battle plan, a separate mission plan for the corresponding aircraft on which the mission plan generator is operating. Each mission plan includes task sets for completion by the corresponding aircraft and a route to be traversed by the corresponding aircraft. Each task set includes tasks, which when completed, are designed to achieve one of the one or more mission objectives of the battle plan, including achieving the desired battle space effects, guidance, and aircraft constraints of the mission objective.

In some example implementations, the system 200 includes a mission execution block 206 configured to execute the mission plan generated for the corresponding aircraft. Each instance of the system is configured to execute its corresponding mission plan, which causes the corresponding aircraft being configured to traverse the route, such as one of first route 104A, second route 104B, or third route 104C, and complete the tasks from the task sets of a corresponding mission plan.

The system 200, or each instance thereof, is further configured to receive observed real-time battlespace conditions 210 from sub-surface, surface, ground, air, and/or space-based sensors 208. For example, the observed real-time battlespace conditions are received from sub-surface, surface, ground, air, and/or space-based sensors, including one or more ground-based radar devices, one or more airborne devices, one or more sub-surface sensors, one or more spaceborne devices, one or more ground-based sensors, or one or more airborne sensors arranged to monitor and track one or more locations on the battlespace, positions of the one or more aircraft, and positons of one or more enemy aircraft on the battlespace. In another example, the observed real-time battlespace conditions can be received from a satellite in space. In yet another example, the observed real-time battlespace conditions can be received from intelligence based updates, such as from a person or robot that witnesses a battlespace condition and alerts the system. In such an example the person or robot could be on the ground, in one of the one or more aircraft, or in any other aircraft, vehicle, spacecraft, or in any other position that can observe the battlespace conditions. In addition, the system can receive updates to the battle plan itself such as a new target, moved mission objective, altered constraints, and the like.

In some examples, the observed real-time battlespace conditions 210 includes enemy combatant movements, new or unexpected enemy combatant entities (e.g., artillery, ground or aerial obstacles, weather changes, and the like), or any other suitable changes that create a scenario where the mission plan should be revised. In instances where the observed real-time battlespace conditions are received, the mission plan generator 204 of the system 200 is configured to generate a revised mission plan for at least one selected aircraft based on the observed real-time battlespace conditions. That is, not all of the aircraft will need to have a revised mission plan, so the collective system will only generate a new mission plan for appropriate aircraft (e.g., the at least one selected aircraft) based on the observed real-time battlespace conditions. In some implementations, the revised mission plan includes one or more adjustments to the route or task sets of the corresponding mission plan. Upon generating the revised mission plan, the mission execution block 206 is configured to execute the revised mission plan, including the selected aircraft traversing the adjusted route or completing the adjusted task set.

For example, in the battlespace illustrated in FIG. 1, the target 108 is mobile and moves 500 feet to the left, out of the second route 104B of the second aircraft 102B. Part of the original mission plan for the second aircraft is to destroy the target. The observed real-time battlespace conditions includes information characterizing the movement of the target 500 feet to the left and that data is received by the second aircraft. The instance of the system 200 on the second aircraft then revises its mission to change the route to take the second aircraft close enough to the moved target to destroy the target.

The revised mission plan executed by the selected aircraft, in some examples, creates a situation where the mission plans of the other aircraft operating instances of the system 200 need to be revised as well. The system further comprises a mission sharing block 212 configured for sharing either the original mission plan or the revised mission plan to various other systems. For example, the system is configured to transmit, e.g., via transceiver 213, the revised mission plan to each of the other aircraft for revising their corresponding mission plans. Additionally, in some example implementations, the mission sharing block is further configured to display instructions for executing each mission plan or each revised mission plan on an onboard computer display 220 of a corresponding aircraft.

In some example implementations of the disclosed system 200, each of the one or more processors 201 is further configured to determine mission requirements for subsystems of the corresponding aircraft on which the processor is located, based on the received mission objective to be completed during execution of the mission plan, and based on expected battlespace conditions. Each of the one or more processors is further configured to generate the task sets and the route based on the determined mission requirements. Each of the one or more processors is further configured to determine revised mission requirements for subsystems of the corresponding aircraft based on the received mission objective to be completed during execution of the mission plan, and based on the observed real-time battlespace conditions. Each of the one or more processors is further configured to adjust the task sets and the route based on the determined revised mission requirements. In some implementations, the revised mission requirements for each aircraft can be generated to collectively accomplish a single goal.

In some example implementations of the disclosed system 200, each mission objective further contains one or more pre-loaded template mission plans for execution by an aircraft. In such example implementations, each of the one or more processors 201 is further configured to use the pre-loaded template mission plans to generate the mission plans, the pre-loaded template mission plans comprising pre-made task sets and routes being representative of a pre-determined decision making or task prioritization process. In some example implementations, each of the one or more processors is further configured to alter the pre-loaded template mission plan based on expected battlespace conditions to generate the mission plans. In some example implementations, each of the one or more processors is further configured to alter the pre-loaded template mission plan based on observed actual battlespace conditions, including environmental conditions, obstacles, or enemy combatant locations or activities.

In some example implementations of the disclosed system 200, each of the one or more processors 201 is further configured to generate a plurality of mission plan options from which a pilot of a corresponding aircraft selects to execute. In some example implementations, routes and task sets of the mission plan options are editable by the pilot.

FIG. 3A illustrates a battlespace 300 with an instance of the system 200 onboard each of the aircraft, such as first aircraft 102A, second aircraft 102B, and third aircraft 102C, in the battlespace, according to some embodiments of the present disclosure. As illustrated in FIG. 3A, each of the aircraft are configured to communicate with one another via communication links 302 to coordinate their mission plans to achieve the objectives set forth in the battle plan. As described herein, upon changing their mission plan based on the observed real-time battlespace conditions, the aircraft are configured to share their changes with each of the other aircraft as indicated by the communication links.

FIG. 3B illustrates communication environment 350 including first aircraft 102A, second aircraft 102B, and third aircraft 102C on the battlespace 300. Similar to the illustration in FIG. 3A, each of the aircraft include communication links 302 for establishing communication with each other, but also to ground station 354. In some example implementations, the ground station includes the battle manager 202 from which the battle plan 203 is generated and transmitted. Furthermore, as described above, the observed real-time battlespace conditions are received from ground sensors, including one or more ground-based radar devices or one or more other ground-based sensors, arranged to monitor and track one or more locations on the battlespace, positions of the one or more aircraft, and positions of one or more enemy aircraft on the battlespace. In some implementations, the ground-based radar devices or one or more other ground-based sensors are located in the ground station or are in communication with the ground station and the ground station can receive their data outputs and transmit the data outputs to the aircraft.

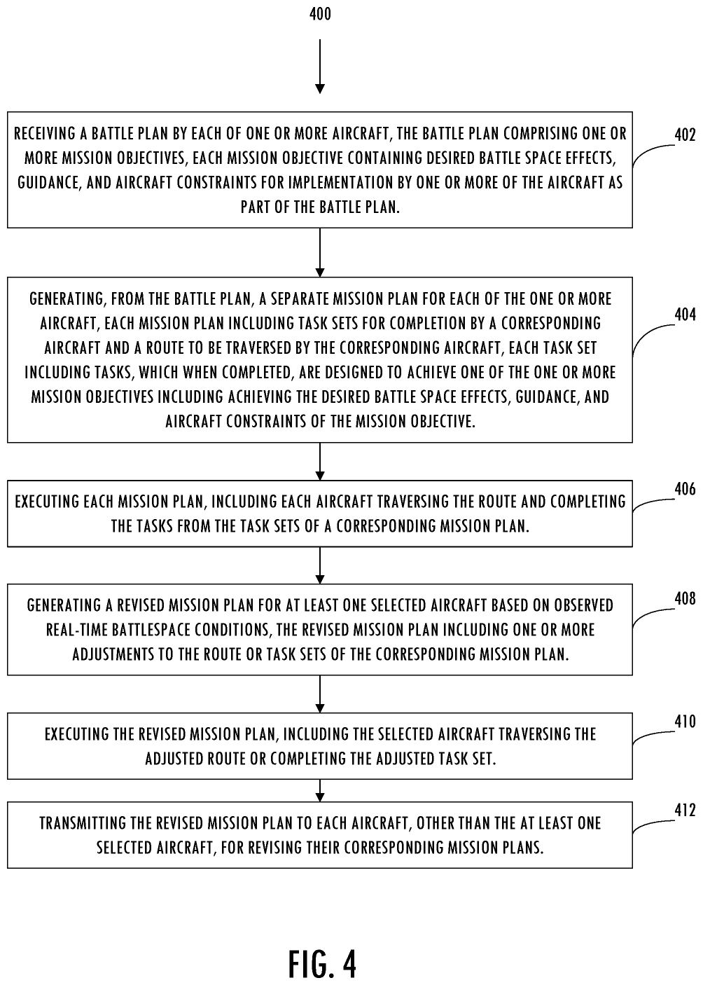

FIG. 4 illustrates a flow chart of an example method 400 for managing an air combat mission on a battlespace for one or more aircraft. As shown at block 402, the method includes receiving a battle plan by each of the one or more aircraft, the battle plan comprising one or more mission objectives, each mission objective containing desired battle space effects, guidance, and aircraft constraints for implementation by one or more of the aircraft as part of the battle plan. As shown at block 404, the method includes generating, from the battle plan, a separate mission plan for each of the one or more aircraft, each mission plan including task sets for completion by a corresponding aircraft and a route to be traversed by the corresponding aircraft, each task set including tasks, which when completed, are designed to achieve one of the one or more mission objectives including achieving the desired battle space effects, guidance, and aircraft constraints of the mission objective. As shown at block 406, the method includes executing each mission plan, including each aircraft traversing the route and completing the tasks from the task sets of a corresponding mission plan.

As shown at block 408, the method includes generating a revised mission plan for at least one selected aircraft based on observed real-time battlespace conditions, the revised mission plan including one or more adjustments to the route or task sets of the corresponding mission plan. As shown at block 410, the method includes executing the revised mission plan, including the selected aircraft traversing the adjusted route or completing the adjusted task set. As shown at block 412, the method includes transmitting the revised mission plan to each aircraft, other than the at least one selected aircraft, for revising their corresponding mission plans.

According to example implementations of the present disclosure, the system 200 for managing an air combat mission on a battlespace 100 for one or more aircraft is implemented by various means. Means for implementing the system includes hardware, alone or under direction of one or more computer programs from a computer-readable storage medium. In some examples, one or more apparatuses are configured to function as or otherwise implement the system shown and described herein. In examples involving more than one apparatus, the respective apparatuses are connected to or otherwise in communication with one another in a number of different manners, such as directly or indirectly via a wired or wireless network or the like.

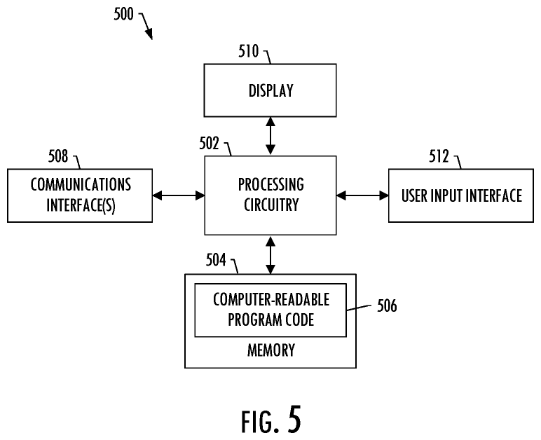

FIG. 5 illustrates an apparatus 500 capable of implementing the system 200 for managing an air combat mission on a battlespace 100 according to some example implementations of the present disclosure that is collocated. The apparatus 500 is an example device that is used to implement the methods and functions described above with respect to the system for managing an air combat mission. Generally, an apparatus of exemplary implementations of the present disclosure comprises, includes, or is embodied in one or more fixed or portable electronic devices. Examples of suitable electronic devices include a microcontroller, controller, smartphone, tablet computer, laptop computer, desktop computer, workstation computer, server computer or the like. The apparatus includes one or more of each of a number of components such as, for example, processing circuitry 502 (e.g., processor unit or computer processor) connected to a memory 504 (e.g., storage device).

The processing circuitry 502 is composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which is packaged as an integrated circuit or multiple interconnected integrated circuits (an integrated circuit at times more commonly referred to as a “chip”). The processing circuitry is configured to execute computer programs, which are stored onboard the processing circuitry or otherwise stored in the memory 504 (of the same or another apparatus).

The processing circuitry 502 includes a number of processors, a multi-core processor or some other type of processor, depending on the particular implementation. Further, the processing circuitry is implemented using a number of heterogeneous processor systems in which a main processor is present with one or more secondary processors on a single chip. As another illustrative example, the processing circuitry is a symmetric multi-processor system containing multiple processors of the same type. In yet another example, the processing circuitry is embodied as or otherwise include one or more ASICs, FPGAs or the like. Thus, although the processing circuitry is capable of executing a computer program to perform one or more functions, the processing circuitry of various examples is capable of performing one or more functions without the aid of a computer program. In either instance, the processing circuitry is appropriately programmed to perform functions or operations according to example implementations of the present disclosure.

The memory 504 is generally any piece of computer hardware that is capable of storing information such as, for example, data, computer programs (e.g., computer-readable program code 506) and/or other suitable information either on a temporary basis and/or a permanent basis. The memory includes volatile and/or non-volatile memory, and is fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks include compact disk-read only memory (CD-ROM), compact disk-read/write (CD-R/W), DVD or the like. In various instances, the memory is referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein generally refer to a computer-readable storage medium or computer-readable transmission medium.

In addition to the memory 504, the processing circuitry 502 is also connected to one or more interfaces for displaying, transmitting and/or receiving information. The interfaces include a communications interface 508 (e.g., communications unit) and/or one or more user interfaces. The communications interface is configured to transmit and/or receive information, such as to and/or from other apparatus(es), network(s) or the like. The communications interface is configured to transmit and/or receive information by physical (wired) and/or wireless communications links. Examples of suitable communication interfaces include a network interface controller (NIC), wireless NIC (WNIC) or the like.

The user interfaces include a display 510 and/or one or more user input interfaces 512 (e.g., input/output unit). The display is configured to present or otherwise display information to a user, suitable examples of which include a liquid crystal display (LCD), light-emitting diode display (LED), plasma display panel (PDP) or the like. The user input interfaces are wired or wireless, and are configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces further include one or more interfaces for communicating with peripherals such as printers, scanners or the like.

As indicated above, program code instructions are stored in memory, and executed by processing circuitry that is thereby programmed, to implement functions of the systems, subsystems, tools and their respective elements described herein. As will be appreciated, any suitable program code instructions are loaded onto a computer or other programmable apparatus from a computer-readable storage medium to produce a particular machine, such that the particular machine becomes a means for implementing the functions specified herein. These program code instructions are also stored in a computer-readable storage medium that direct a computer, a processing circuitry or other programmable apparatus to function in a particular manner to thereby generate a particular machine or particular article of manufacture. The instructions stored in the computer-readable storage medium produce an article of manufacture, where the article of manufacture becomes a means for implementing functions described herein. The program code instructions are retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions are performed sequentially such that one instruction is retrieved, loaded and executed at a time. In some example implementations, retrieval, loading and/or execution are performed in parallel such that multiple instructions are retrieved, loaded, and/or executed together. Execution of the program code instructions produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, the apparatus 500 includes the processing circuitry 502 and the computer-readable storage medium or memory 504 coupled to the processing circuitry, where the processing circuitry is configured to execute computer-readable program code 506 stored in the memory. It will also be understood that one or more functions, and combinations of functions, are implemented by special purpose hardware-based computer systems and/or processing circuitry which perform the specified functions, or combinations of special purpose hardware and program code instructions.

Many modifications and other implementations of the inventions set forth herein will come to mind to one skilled in the art to which these disclosed implementations pertain having the benefit of the teachings presented in the foregoing descriptions and the associated drawings. Therefore, it is to be understood that implementations of the invention are not to be limited to the specific implementations disclosed and that modifications and other implementations are intended to be included within the scope of the invention. Moreover, although the foregoing descriptions and the associated drawings describe example implementations in the context of certain example combinations of elements and/or functions, it should be appreciated that different combinations of elements and/or functions is provided by alternative implementations without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. is used herein to describe various steps or calculations, these steps or calculations should not be limited by these terms. These terms are only used to distinguish one operation or calculation from another. For example, a first calculation is termed a second calculation, and, similarly, a second step is termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular implementations only and is not intended to be limiting.

That which is claimed:

1. A method for managing an air combat mission on a battlespace for one or more aircraft, the method comprising:
receiving a battle plan by each of the one or more aircraft, the battle plan comprising one or more mission objectives, each mission objective containing desired battle space effects, guidance, and aircraft constraints for implementation by one or more of the aircraft as part of the battle plan;
generating, from the battle plan, a separate mission plan for each of the one or more aircraft, each mission plan including task sets for completion by a corresponding aircraft and a route to be traversed by the corresponding aircraft, each task set including tasks, which when completed, are designed to achieve one of the one or more mission objectives including achieving the desired battle space effects, guidance, and aircraft constraints of the mission objective;
executing each mission plan, including each aircraft traversing the route and completing the tasks from the task sets of a corresponding mission plan;
generating a revised mission plan for at least one selected aircraft based on observed real-time battlespace conditions, the revised mission plan including one or more adjustments to the route or task sets of the corresponding mission plan;
executing the revised mission plan, including the selected aircraft traversing the adjusted route or completing the adjusted task set; and
transmitting the revised mission plan to each aircraft, other than the at least one selected aircraft, for revising their corresponding mission plans.

2. The method of claim 1, wherein generating the mission plans from the battle plans comprises:
determining mission requirements for subsystems of each aircraft based on the received mission objective to be completed during execution of the mission plan, and based on expected battlespace conditions; and
generating the task sets and the route based on the determined mission requirements.

3. The method of claim 1, wherein generating the revised mission plan comprises:
determining revised mission requirements for subsystems of each aircraft based on the received mission objective to be completed during execution of the mission plan, and based on the observed real-time battlespace conditions; and
adjusting the task sets and the route based on the determined revised mission requirements.

4. The method of claim 1, further comprising displaying instructions for executing each mission plan or each revised mission plan on an onboard computer display of a corresponding aircraft.

5. The method of claim 1, wherein each mission objective further contains one or more pre-loaded template mission plans for execution by an aircraft, and
wherein generating the mission plans comprises using the pre-loaded template mission plans to generate the mission plans, the pre-loaded template mission plans comprising pre-made task sets and routes being representative of a pre-determined decision making or task prioritization process.

6. The method of claim 5, wherein generating the mission plans further comprises altering the pre-loaded template mission plan based on expected battlespace conditions to generate the mission plans.

7. The method of claim 6, wherein altering the pre-loaded template mission plan includes altering the pre-loaded template mission plan based on observed actual battlespace conditions, including environmental conditions, obstacles, or enemy combatant locations or activities.

8. The method of claim 1, further comprising receiving the observed real-time battlespace conditions from one or more ground-based radar devices, one or more airborne devices, one or more ground-based sensors, or one or more airborne sensors arranged to monitor and track one or more locations on the battlespace, positions of the one or more aircraft, and positions of one or more enemy aircraft on the battlespace.

9. The method of claim 1, wherein generating the mission plan for each of the aircraft includes generating a plurality of mission plan options from which a pilot of a corresponding aircraft is able to select to execute.

10. The method of claim 9, wherein routes and task sets of the mission plan options are editable by the pilot.

11. A system for managing an air combat mission on a battlespace for one or more aircraft, the system comprising:
one or more processors, each including non-transitory computer readable storage medium having executable instructions stored thereon, each of the one or more aircraft having one of the one or more processors onboard, wherein upon execution of the executable instructions, the one or more processors is configured to:
receive a battle plan by each of the one or more aircraft, the battle plan comprising one or more mission objectives, each mission objective containing desired battle space effects, guidance, and aircraft constraints for implementation by one or more of the aircraft as part of the battle plan;
generate, from the battle plan, a separate mission plan for each of the one or more aircraft, each mission plan including task sets for completion by a corresponding aircraft and a route to be traversed by the corresponding aircraft, each task set including tasks, which when completed, are designed to achieve one of the one or more mission objectives including achieving the desired battle space effects, guidance, and aircraft constraints of the mission objective;
execute each mission plan, including each aircraft being configured to traverse the route and complete the tasks from the task sets of a corresponding mission plan;
generate a revised mission plan for at least one selected aircraft based on observed real-time battlespace conditions, the revised mission plan including one or more adjustments to the route or task sets of the corresponding mission plan;
execute the revised mission plan, including the selected aircraft being configured to traverse the adjusted route or complete the adjusted task set; and
transmit the revised mission plan to each aircraft, other than the at least one selected aircraft, for revising their corresponding mission plans.

12. The system of claim 11, wherein the one or more processors is further configured to:
determine mission requirements for subsystems of each aircraft based on the received mission objective to be completed during execution of the mission plan, and based on expected battlespace conditions; and
generate the task sets and the route based on the determined mission requirements.

13. The system of claim 11, wherein the one or more processors is further configured to:
determine revised mission requirements for subsystems of each aircraft based on the received mission objective to be completed during execution of the mission plan, and based on the observed real-time battlespace conditions; and
adjust the task sets and the route based on the determined revised mission requirements.

14. The system of claim 11, wherein the one or more processors is further configured to display instructions for executing each mission plan or each revised mission plan on an onboard computer display of a corresponding aircraft.

15. The system of claim 11, wherein each mission objective further contains one or more pre-loaded template mission plans for execution by an aircraft, and
wherein the one or more processors is further configured to use the pre-loaded template mission plans to generate the mission plans, the pre-loaded template mission plans comprising pre-made task sets and routes being representative of a pre-determined decision making or task prioritization process.

16. The system of claim 15, wherein the one or more processors is further configured to alter the pre-loaded template mission plan based on expected battlespace conditions to generate the mission plans.

17. The system of claim 16, wherein the one or more processors is further configured to alter the pre-loaded template mission plan based on observed actual battlespace conditions, including environmental conditions, obstacles, or enemy combatant locations or activities.

18. The system of claim 11, wherein the one or more processors is further configured to receive the observed real-time battlespace conditions from one or more ground-based radar devices, one or more airborne devices, one or more ground-based sensors, or one or more airborne sensors arranged to monitor and track one or more locations on the battlespace, positions of the one or more aircraft, and positions of one or more enemy aircraft on the battlespace.

19. The system of claim 11, wherein the one or more processors is further configured to generate a plurality of mission plan options from which a pilot of a corresponding aircraft is able to select to execute.

20. The system of claim 19, wherein routes and task sets of the mission plan options are editable by the pilot.
